(19) United States
(12) Patent Application Publication
(10) Pub. No.: US 2018/0229524 A1
(43) Pub. Date: Aug. 16, 2018

(54) SUBSTRATE COATING

(71) Applicant: HP SCITEX LTD., Netanya (IL)

(72) Inventors: Jason Swei, San Diego, CA (US); Colin Egan, San Diego, CA (US); Guillermo Martinez Ariza, San Diego, CA (US); Yubai Bi, San Diego, CA (US); Jon A. Crabtree, San Diego, CA (US); Stephen W. Bauer, San Diego, CA (US)

(73) Assignee: HP SCITEX LTD., Netanya (IL)

(21) Appl. No.: 15/898,826

(22) Filed: Feb. 19, 2018

(30) Foreign Application Priority Data
Feb. 16, 2017 (EP) 17156561.7

(51) Int. Cl. B41M 3/00; B41F 5/24; B41F 31/32

(52) U.S. Cl. CPC B41M 3/006; B41F 31/32; B41F 5/24

(57) ABSTRACT

In an example implementation, a substrate coating system includes a resist printing device to print resist fluid onto a selected area of a substrate surface. The system includes an analog coating device to apply coating fluid onto the entire substrate surface, wherein the resist fluid resists application of the coating fluid on the selected area of the substrate surface.

### BACKGROUND

Global trends in developed and emerging markets continue to drive increasing demand and rapid growth in the product packaging industry. Sales in the global product packaging market are in the hundreds of billions of dollars. In addition to protecting and extending the shelf life of countless products of all different types, product packaging provides a valuable opportunity for product developers to market their products through aesthetically pleasing packaging designs. Efforts toward continued development and improvement of product packaging and other related media products are ongoing.

### BRIEF DESCRIPTION OF THE DRAWINGS

Examples will now be described with reference to the accompanying drawings, in which:

FIG. 1 shows an example of a substrate coating system that is suitable for coating media substrates with a patterned coating;

FIG. 2 shows an example of a substrate coating system that includes a controller to enable digital control over the patterning of resist fluid onto incoming media substrates;

FIG. 3 shows an example of a substrate coating system during operation, in which a resist printer comprises a digital printing device to digitally control the patterning of resist fluid onto a media substrate;

FIGS. 4 and 5 are flow diagrams showing example methods of coating a substrate.

Throughout the drawings, identical reference numbers designate similar, but not necessarily identical, elements.

### DETAILED DESCRIPTION

Printed packaging has long played a role in the marketing and sales of products. Well-designed, high quality packaging used for shipping, handling, and displaying products can attract the attention of consumers and help to generate increased interest and sales of many different types of products. One technique used in the package printing industry to produce high quality prints on packaging is to apply a clear, protective coating over the packaging substrates after the package substrates have been printed. In some examples, a “primer” coating can be applied before the package substrates have been printed. One example of a coating often applied to printed package substrates is an over print varnish (OPV). OPVs provide a wide variety of functionality to packaging, including improved durability, gloss, texture, non-skid surfaces, and so on.

In some examples, applying coatings such as OPVs onto package substrates includes patterning the coating in a manner that avoids putting the coating onto particular areas of the package substrates. These areas are often referred to as “knockouts”, and they can include, for example, areas where glue or imprinting is to be subsequently applied to complete construction of the package, areas where the substrate has been previously imprinted, and so on. In some examples, patterned coatings can be applied to packaging substrates using an analog flexography process. In such flexography processes, the entire surface of the substrate sheet can be covered with an OPV or other coating except for those areas specifically patterned as knockouts.

The use of analog printing techniques such as flexography to apply OPV or other coating fluids onto packaging substrates works well when printing long-run package print jobs where the patterning of the knockouts does not change from one substrate to the next. However, the growing use of digital printing within the product packaging industry enables a print-on-demand capability that supports print jobs with varying patterns of printed imaging that can adjust the knockout locations “on-the-fly” between individual printed substrates within a single print job. Digital printing enables variable data printing within predetermined patterns on packaging substrates, as well as enabling virtually infinite adjustments to be made to the patterning and placement of imprinted images onto packaging substrates. Such patterning adjustments can be made “on-the-fly” within short-run or long-run print jobs so that consecutively printed packaging substrates can each have different image patterning and different image content.

Because flexography and other analog processes are incapable of changing the knockout patterning of OPV coatings “on-the-fly”, they are mostly incompatible with realizing the full benefits offered by digital package printing. With analog flexography, for example, adjusting the OPV knockout patterning to accommodate for continually variable printed imaging on digitally printed package substrates would involve removing the flexographic printing plate for each substrate, and then replacing it with a new plate that is appropriately patterned. Changing the printing plate involves printing downtime and significant cost which can present a barrier to the adoption of digital package printing for many printed packaging providers.

In general, digital printing applied to the package printing industry enables unlimited variety in packaging design that creates increased value in areas of product marketing and sales. Achieving high quality digital prints, however, entails the application of protective coatings such as OPV, and the variability enabled by digital printing is not compatible with analog processes used for applying such coatings. Current digital OPV coating application technologies such as valve plunger displacement, piezo ejection, and modulated stream systems, are mostly immature electro-mechanical solutions that are expensive and favor low resolution coating. Furthermore, formulating OPV fluids that are both compatible with digital dispersion methods and capable of replicating the different functionalities of the analog OPVs is challenging and costly. For example, OPVs and other coatings comprise high viscosity fluids, and formulating these fluids for dispersion from digital technologies may involve considerable dilution of the fluids. Therefore, applying highly diluted OPV fluids through an inkjet printhead, for example, entails dispersing high quantities of fluid onto substrates. Too much fluid can cause mechanical deformation of substrates, including cockling, curling, and wrinkling of the substrate. Thus, while digital printing enables efficient variability in printing patterns from one substrate to the next, flexography and other analog OPV coating application methods do not.

Accordingly, examples of systems and methods described herein enable the application of patterned coatings onto media substrates by combining different fluid application processes. In some examples, a process for patterning a resist fluid onto the surface of a media substrate is combined with an analog coating process to achieve a patterned coating on the substrate. A resist fluid can be applied to a media substrate using any of a variety of methods that enable patterning the resist fluid onto the substrate surface in certain knockout locations where the application of coating fluid is to be prevented. The coating fluid can then be applied through an analog coating process in a manner designed to coat the entire surface of the substrate. The patterned resist fluid, however, works to prevent the transfer of the coating fluid onto the substrate in the knockout areas, which results in the application of an appropriately patterned coating fluid on the substrate. Thus, when patterned onto the substrate surface, the resist fluid resists the coating fluid. In this regard, the resist fluid may be referred to herein as a “patterned fluid resist”, a “patterned resist”, or a “fluid resist”, once it has been applied in a pattern onto the media substrate. The application of patterned coatings in this manner can be implemented both before a media substrate has been printed, as a pre-print “primer” coating, as well as after the media substrate has been printed, as a post-print protective coating.

In a particular example, a substrate coating system includes a resist printing device to print resist fluid onto a selected area of a substrate surface. The system also includes an analog coating device to apply coating fluid to the entire substrate surface, wherein the resist fluid resists application of the coating fluid to the selected area of the substrate surface. In different examples, the resist printing device can be a digital printing device or an analog printing device.

In another example, a non-transitory machine-readable storage medium stores instructions that when executed by a processor of a substrate coating system, cause the system to receive a printed media substrate and to print resist fluid onto an area of the substrate. The resist fluid is to prevent application of a coating fluid onto the area of the substrate where the resist fluid has been printed. The system then flood coats the substrate with the coating fluid.

In another example, a substrate coating system includes a digital printing device to print resist fluid onto a media substrate, and an analog printing device to coat the media substrate with a coating. The system also includes a memory device that stores print instructions and print data, and a processor programmed to execute the print instructions to control printing of patterned resist fluid on the media substrate in knockout areas according to information in the print data.

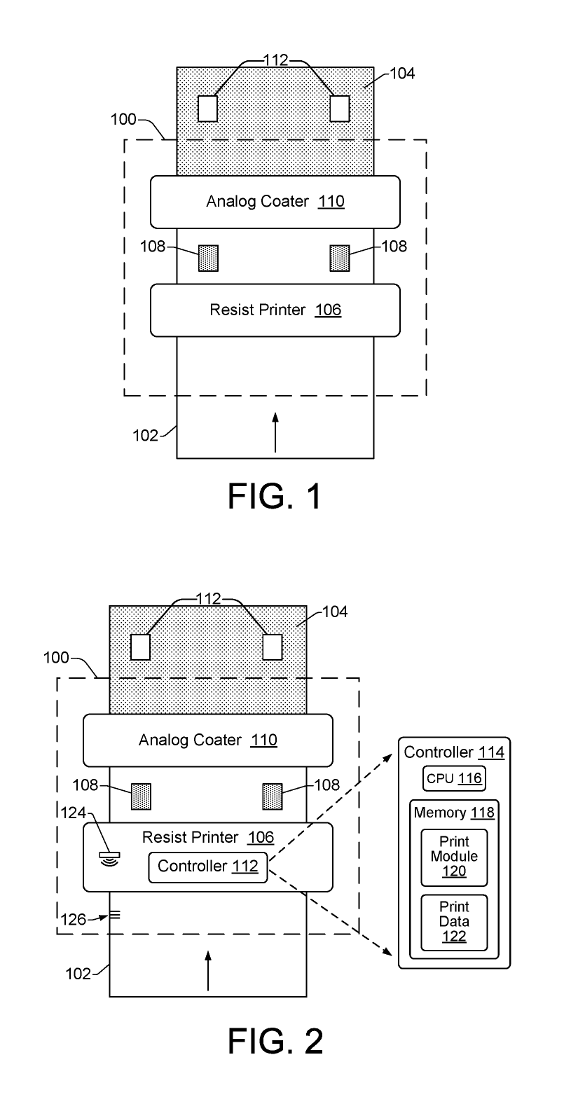

FIG. 1 shows an example of a substrate coating system 100 that is suitable for coating media substrates 102 with a patterned coating 104. Media substrates 102 can be received, for example, from a printing device (not shown) after being imprinted with text and other imaging. In some examples, media substrates 102 can be received prior to being imprinted with text or other imaging. A media substrate 102 can include a variety of printable media substrates such as substrates used in product packaging. Examples of media substrates 102 include, but are not limited to, various plastics such as polyolefin, polyester, polyethylene terephthalate, and polyvinyl chloride; papers such as kraft paper, sulfite paper, and greaseproof paper; and single and multi-layer paperboards such as white board, solid board, chipboard, fiberboard, and corrugated cardboard. A patterned coating 104 can include coatings such as over print varnish (OPV) coatings, UV coatings with matte or gloss finish, and aqueous coatings. Such coatings can be applied to media substrates 102 such as product packaging substrates to help protect, enhance, and strengthen the substrates.

An example substrate coating system 100 can include a resist printer 106 for printing a patterned fluid resist 108 onto a media substrate 102 surface. The substrate coating system 100 can also include a flood coating device 110 such as an analog coater 110 to apply a coating fluid onto the media substrate 102 surface after a patterned fluid resist 108 has been applied. A media substrate 102 generated by the coating system 100 can have a patterned coating 104 that includes knockout areas 112 where the patterned fluid resist 108 resists application of a coating fluid from the analog coater 110. A resist printer 106 can include any of a variety of printing devices capable of applying a patterned fluid resist 108 onto a media substrate 102. In different examples a resist printer 106 can comprise a digital printing device or an analog printing device.

Whether the resist printer 106 is implemented as a digital printing device or an analog printing device, however, the resist printer 106 is capable of adjusting or varying the patterned fluid resist 108 being printed onto the media substrate 102. For example, a resist printer 106 implemented as an analog flexographic printing device can enable adjustment of the patterned fluid resist 108 through the removal and replacement of a printing plate from a printing plate cylinder. The replacement printing plate can have a different application design for patterning resist fluid on the media substrate 102. While changing a printing plate in an analog printing device can be time consuming, implementing the resist printer 106 as an analog printing device can be useful under circumstances in which the patterned fluid resist 108 is to remain constant for long printing runs in which a large quantity of media substrates 102 are to be produced with the same patterned coating 104. Under such circumstances, a flexographic printing device or other analog printing device can provide high speed printing of patterned fluid resist 108 onto a wide variety of different substrates.

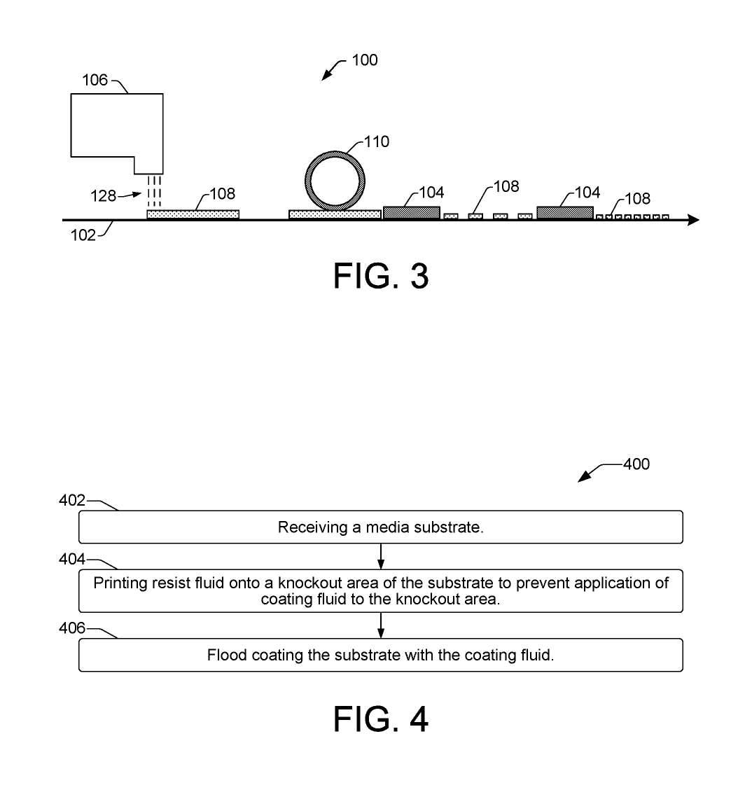

In other examples, a resist printer 106 can be implemented as a digital printing device such as an inkjet printing device. Such devices enable drop-on-demand deposition of patterned fluid resist 108 onto the media substrate 102. A resist printer 106 implemented as a digital printing device can adjust the patterning of resist fluid “on-the-fly” based on digital print data defining images and other “knockout” areas on the media substrate 102, as discussed below. FIG. 2 shows an example of a substrate coating system 100 in which the resist printer 106 comprises a digital printing device to digitally control the patterning of resist fluid on the media substrate 102. FIG. 3 shows an example of a substrate coating system 100 during operation, in which the resist printer 106 comprises a digital printing device to digitally control the patterning of resist fluid 128 on the media substrate 102.

Referring now generally to FIGS. 2 and 3, a substrate coating system 100 can include a controller 114 to enable digital control over the patterning of resist fluid 128 onto incoming substrates 102 received, for example, from a printing device (not shown). The controller 114 can also control various other operations of the substrate coating system 100 to facilitate the application of a patterned coating onto the incoming substrates 102. As shown in FIG. 2, an example controller 114 can include a processor (CPU) 116 and a memory 118. The controller 114 may additionally include other electronics (not shown) for communicating with and controlling various components of the substrate coating system 100. Such other electronics can include, for example, discrete electronic components and/or an ASIC (application specific integrated circuit). Memory 118 can include both volatile (i.e., RAM) and nonvolatile memory components (e.g., ROM, hard disk, optical disc, CD-ROM, magnetic tape, flash memory, etc.). The components of memory 118 can comprise non-transitory, machine-readable (e.g., computer/processor-readable) media that can provide for the storage of machine-readable coded program instructions, data structures, program instruction modules, PDL (page description language), PCL (printer control language), JDF (job definition format), 3MF formatted data, and other data and/or instructions executable by a processor 116 of the substrate coating system 100.

An example of executable instructions to be stored in memory 118 include instructions associated with a print module 120, while examples of stored data can include print data 122. In general, module 120 can include programming instructions executable by processor 116 to cause the resist printer 106 to deposit resist fluid 128 onto a media substrate 102 in a pattern of fluid resist 108 according to information defined within print data 122. Print data 122 can include information about text and other images printed on a media substrate 102, as well as information about where knockouts are to be located on a media substrate 102.

Referring still to FIGS. 2 and 3, when the substrate coating system 100 receives a media substrate 102, the processor 116 can execute print module 120 instructions that cause the resist printer 106 to align the media substrate 102 in preparation for depositing a resist fluid 128 onto the substrate. In one example of an alignment process, a sensor 124 on the resist printer 106 can read or otherwise sense an alignment marking 126 on the media substrate 102 as the substrate 102 is received by the substrate coating system 100. A sensor 124 can comprise, for example, a photoelectric sensor such as a retro-reflective sensor or a opposed through-beam sensor to determine the presence of the alignment marking 126. The alignment marking 126 can include a printed marking or a notch or other physical formation on the media substrate detectable by the sensor 124. Other processes and mechanisms for aligning a media substrate 102 are also possible and contemplated herein.

As the media substrate 102 passes through the resist printer 106, the print module 120 causes the resist printer 106 to deposit resist fluid 128 onto a media substrate 102 as a patterned fluid resist 108 in accordance with the imaging and knockout information from the print data 122. A patterned fluid resist 108 printed onto a media substrate 102 resists a subsequent application of coating fluid by the analog coater 110. Thus, the patterned fluid resist 108 and the coating pattern 104 are inverse patterns. In some examples, in addition to controlling the deposition of resist fluid 128 onto a media substrate 102, the print module 120 can additionally execute on a processor 116 to cause the analog coater 110 to operate to apply a fluid coating onto the media substrate 102 after the substrate 102 has been printed with a patterned fluid resist 108 by resist printer 106. Such operations performed by execution of instructions on a processor 116 can include, for example, the operations of a method 400, described below with respect to FIG. 4.

While a resist printer 106 has generally been discussed as comprising a digital inkjet printing device or an analog flexographic coating device, a resist printer 106 is not limited to such implementations. For example, a resist printer 106 may be implemented as various digital printing devices capable of digitally controlling the deposition of a resist fluid onto a media substrate. Examples of such digital printing devices include thermal inkjet printers, piezo inkjet printers, continuous flow inkjet printers, and so on. Examples of analog coating devices and/or processes can include flexographic coating devices, gravure coating, reverse roll coating, knife-over-roll coating (“gap coating”), metering rod (meyer rod) coating, slot die (slot, extrusion) coating, immersion coating, curtain coating, and air-knife coating. Furthermore, while the analog coater 110 has generally been discussed as comprising a flexographic coating device, other analog coating devices and processes are also contemplated, including those mentioned above.

As noted above, the resist fluid 128 can be deposited as a patterned fluid resist 108 to resist a subsequent application of an OPV or other coating fluid onto the media substrate 102. The patterned fluid resist 108 comprising resist fluid 128 can work by any mechanism that either prevents the OPV or other coating fluid from completely transferring to the media substrate 102 or locally changes the coating properties. Such mechanisms can include, for example: repulsion, where the coating fluid is repelled by the resist fluid through a mechanism such as hydrophobic interaction; non-wetting, where the surface tension of the resist fluid prevents the coating fluid from wetting its surface; dilution, where the resist fluid effectively thins the coating fluid to minimize dry solids in the knockout areas; lubrication, where the coating fluid adheres to the media substrate but slips off the resist fluid; and chemical interaction such as protonation of the coating dispersions.

Furthermore, as illustrated in FIG. 3, the resist fluid 128 may comprise a self-dissipating resist fluid, in that it dissipates, disperses, dissolves, disintegrates, or otherwise “goes away” on its own. In this respect, the resist fluid 128 may be referred to as a fugitive resist fluid. In this example, when the resist fluid 128 is applied as a patterned fluid resist 108, it dissipates on its own from the media substrate 102 as a function of time. A “resist stripping” operation is not needed to remove the patterned fluid resist 108 because the resist fluid 128 dissipates from the media substrate 102 on its own. As shown in FIG. 3, this dissipating characteristic of the resist fluid 128 is illustrated by a decreasing size and presence over time of the patterned fluid resist 108 on the media substrate 102. The amount of time it takes for the resist fluid 128 in the patterned fluid resist 108 to dissipate from the media substrate 102 is on the order of one second. However, in different examples, the dissipation time can be more or less than one second.

Examples of resist fluid chemistries include thermal inkjet capable aqueous fluids. Such fluids can include at least one surfactant, one co-solvent, and a biocide. Examples of such fluids can include 18% 1,2 Butanediol; 2% Dowanol TPM; 0.12% Surfynol CT211, with water remainders. Other example fluids can include those in the following table:

TABLE 1

| | Example #1 | Example #2 | Example #3 | Example #4 |
|---|---|---|---|---|
| | (fluid | (fluid | (fluid | (fluid |
| Component | weight %) | weight %) | weight %) | weight %) |
| Glycerol | 30.0 | 30.0 | 0.0 | 0.0 |
| Ethylene glycol | 0.0 | 0.0 | 10.0 | 10.0 |
| Dowanol TPM | 2.0 | 2.0 | 2.0 | 2.0 |
| Capstone | 0.25 | 0.0 | 0.25 | 0.0 |
| FS-35 | | | | |
| Surfynol | 0.6 | 0.12 | 0.6 | 0.12 |
| CT211 (83%) | | | | |
| Water | 67.15 | 67.88 | 87.15 | 87.88 |
| Total amount | 100 | 100 | 100 | 100 |

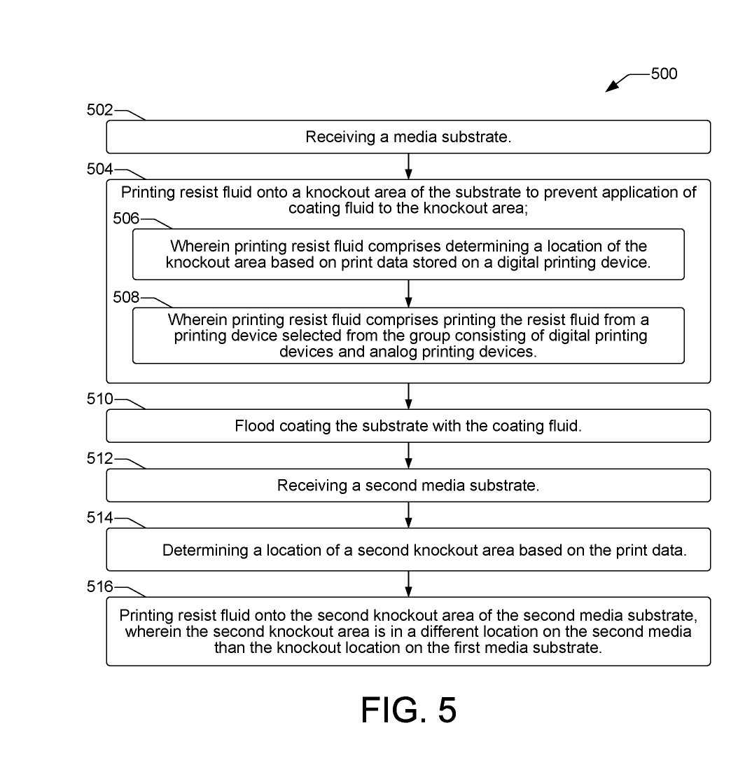

FIGS. 4 and 5 are flow diagrams showing example methods 400 and 500, of coating a substrate. Methods 400 and 500 are associated with examples discussed above with regard to FIGS. 1-3, and details of the operations shown in methods 400 and 500 can be found in the related discussion of such examples. The operations of methods 400 and 500 may be embodied as programming instructions stored on a non-transitory, machine-readable (e.g., computer/processor-readable) medium, such as memory 118 shown in FIG. 2. In some examples, implementing the operations of methods 400 and 500 can be achieved by a processor, such as a processor 116 of FIG. 2, reading and executing the programming instructions stored in a memory 118. In some examples, implementing the operations of methods 400 and 500 can be achieved using an ASIC and/or other hardware components alone or in combination with programming instructions executable by a processor 116.

The methods 400 and 500 may include more than one implementation, and different implementations of methods 400 and 500 may not employ every operation presented in the flow diagrams of FIGS. 4 and 5. Therefore, while the operations of methods 400 and 500 are presented in a particular order, the order of their presentation is not intended to be a limitation as to the order in which the operations may actually be implemented, or as to whether all of the operations may be implemented. For example, one implementation of method 500 might be achieved through the performance of a number of initial operations, without performing one or more subsequent operations, while another implementation of method 500 might be achieved through the performance of all of the operations.

Referring now to the flow diagram of FIG. 4, an example method 400 of coating a substrate begins an block 402 with receiving a media substrate. As shown at block 404, the method can include printing resist fluid onto a knockout area of the substrate to prevent application of coating fluid to the knockout area. The method can then include flood coating the substrate with the coating fluid, as shown at block 406.

Referring now to the flow diagram of FIG. 5, another example method 500 of coating a substrate begins at block 502 with receiving a media substrate. As shown at block 504, the method can include printing resist fluid onto a knockout area of the substrate to prevent application of coating fluid to the knockout area. In some examples, as shown at block 506, printing resist fluid comprises determining a location of the knockout area based on print data stored on a digital printing device. In some examples, as shown at block 508, printing resist fluid comprises printing the resist fluid from a printing device selected from the group consisting of digital printing devices and analog printing devices. The method 500 can then continue at block 510 with flood coating the substrate with the coating fluid.

Method 500 can continue as shown at block 512 with receiving a second media substrate. As shown at block 514, the method can include determining a location of a second knockout area based on the print data. The method can also include, as shown at block 516, printing resist fluid onto the second knockout area of the second media substrate, wherein the second knockout area is in a different location on the second media than the knockout location on the first media substrate.

What is claimed is:

1. A substrate coating system comprising:
a resist printing device to print resist fluid onto a selected area of a substrate surface; and,
an analog coating device to apply coating fluid onto the entire substrate surface, wherein the resist fluid resists application of the coating fluid on the selected area of the substrate surface.

2. A system as in claim 1, wherein the resist printing device comprises a digital printing device to enable automatic adjustment of selected areas of the substrate surface on which resist fluid is to be printed.

3. A system as in claim 2, wherein the digital printing device comprises a drop-on-demand inkjet printing device.

4. A system as in claim 1, wherein the resist printing device comprises an analog printing device.

5. A system as in claim 1, wherein the analog coating device comprises an analog device selected from the group consisting of a flexography coating device, a gravure coating device, a reverse-roll coating device, a knife-over-roll coating device, a Meyer rod coating device, a slot die coating device, an immersion coating device, a curtain coating device, and an air-knife coating device.

6. A system as in claim 1, wherein the resist fluid comprises a fugitive resist fluid that dissipates from the substrate after resisting application of the coating fluid on the selected area of the substrate surface.

7. A system as in claim 6, wherein the fugitive resist fluid dissipates over a period of time on the order of one second in duration.

8. A system as in claim 1, further comprising a sensor to sense a media alignment marking on the media substrate.

9. A non-transitory machine-readable storage medium storing instructions that when executed by a processor of a substrate coating system cause the system to:
receive a media substrate;
print resist fluid onto a knockout area of the substrate to prevent application of coating fluid to the knockout area; and,
flood coat the substrate with the coating fluid.

10. A medium as in claim 9, wherein printing resist fluid comprises determining a location of the knockout area based on print data stored on a digital printing device.

11. A medium as in claim 9, the instructions further causing the system to:
receive a second media substrate;
determine a location of a second knockout area based on the print data; and,
print resist fluid onto the second knockout area of the second media substrate, wherein the second knockout area is in a different location on the second media than the knockout location on the first media substrate.

12. A medium as in claim 9, wherein printing resist fluid comprises printing the resist fluid from a printing device selected from the group consisting of digital printing devices and analog printing devices.

13. A substrate coating system comprising:
a digital printing device to print resist fluid onto a media substrate;
an analog printing device to coat the media substrate with a coating;
a memory device comprising print instructions and print data; and,
a processor programmed to execute the print instructions to control printing of patterned resist fluid on the media substrate in knockout areas according to information in the print data.

14. A substrate coating system as in claim 13, wherein the patterned resist fluid is to prevent application of the coating to the knockout areas such that a coating pattern on the media substrate is a reverse pattern of the patterned resist fluid.

15. A substrate coating system as in claim 13, further comprising a media alignment sensor to align the media substrate prior to printing the resist fluid.
